(19) United States
(12) Patent Application Publication
(10) Pub. No.: US 2010/0127474 A1
(43) Pub. Date: May 27, 2010

(54) Pivoting motorcycle footpeg

(76) Inventor: John Jans, Grass Valley, CA (US)

Correspondence Address: BEESON SKINNER BEVERLY LLP, ONE KAISER PLAZA, SUITE 750, OAKLAND, CA, 94612, US

(21) Appl. No.: 12/313,573

(22) Filed: Nov. 21, 2008

(51) Int. Cl. B62J 25/00

(52) U.S. Cl. 280/291

(57) ABSTRACT

A tortion bar powered partially rotatable footpeg for a motorcycle.

### BACKGROUND OF THE INVENTION

1. Field of the Invention

The present invention relates to a rider adjustable aftermarket foot support apparatus for motorcycles.

More particularly it relates to a pivoting footpeg formed for oscillating motion in response to a motorcycle rider's induced changing angulation of his foot.

Still more particularly the present invention is a spring loaded foot peg which is biased to provide a predetermined orientation of a motorcycle footpad which can be partially rotated or oscillated to accommodate the changing angulation of a motorcycle riders foot and automatically return to the predetermined orientation when the motorcycle rider either takes his foot off of the foot peg or relaxes the rotational pressure he exerts on the footpad.

Specifically, the present invention is a pivotable motorcycle footpeg which is biased to a predetermined orientation by an internally disposed torsion bar.

2. Description of the Prior Art

The use of motorcycle footpegs in one form or another for the purpose of enhancing a motorcycle riders comfort, support, and stability is known in the prior art. Numerous designs, structures, forms of apparatus, and a variety of methods are disclosed by and utilized by the prior art to effect this performance enhancement and necessity. However, the devices and constructions which have been heretofor devised and utilized to accomplish these goals are comprised basically of familiar, expected, and obvious configurations, combinations, and arrangements of well known structural forms and apparatus. This will become apparant from the following consideration of the the closest known and relevant prior art.

Footpegs have been utilized on motorcycles for a long time. Generally they are cantilever projections from the frame of the motorcycle having foot pads which are round or oval as shown and described in U.S. Pat. No. 6,916,034 B2, issued Jul. 12, 2005, to Elliott, and U.S. Pat. No. 7,111,375 B2, issued Sep. 26, 2006, to Buckhouse et al. Some footpegs are partially rotatable for pivoting motion as shown and described in U.S. Pat. No. 5,482,307, issued Jan. 9, 1996, to Lin, and U.S. Pat. No. 6,663,129 B1, issued Dec. 16, 2003, to Smith. These latter two patents are most relevant to the present invention.

The '307 patent to Lin discloses a rotatable footpad on a footpeg which can freely rotate which can be a desirable capability under some circumstances but usually not. Freely rotatable footpads on footpegs do not provide stability to the motorcycle rider's foot to inhibit or resist rocking of the support.

The '129 patent to Smith provides the stability lacking in Lin by providing a spring biased motorcycle footpeg. However, the apparatus supplying the biasing force is a complicated and expensive mechanism employing in excess of at least 15 parts. Due to the low exposed position of a footpeg on a motorcycle, the mechanism can be infused with contaminants such as dirt and dust causing it to malfunction. The expense of manufacture of such a mechanism is considerable and unjustified in comparison with a fixed footpeg.

The pivoting motorcycle foot peg contemplated according to the present invention departs substantially from the conventional concepts and designs taught and used by the prior art, and in doing so, provides an apparatus primarily developed for the purpose of overcoming the problems as described above, but it accomplishes the result in a different and improved manner for producing a pivoting foot peg of a simple minimum parts construction providing a unique actuating mechanism which self centers simply by the motorcycle rider lifting his foot or relaxing pressure on the footpeg. It provides the stability lacking in the Lin '307 patent and a pivoting footpeg like the Smith '129 patent but with a considerably more trouble-free and less expensive and less complicated construction.

### SUMMARY OF THE INVENTION

In view of the foregoing known, obvious, and described disadvantages inherent in the known types of motorcycle foot pegs presently existing in the prior art, the present invention provides a new method, apparatus, and construction for a motorcycle footpeg wherein the same can be employed to provide a more stable pivoting footrest for a motorcycle rider with greater dependability and a less complicated apparatus at a lower cost.

The general purpose construction of the present invention, which will be described hereafter in greater detail, has been designed to provide a new and improved pivoting motorcycle footpeg apparatus which has many of the advantages of the prior art of active motorcycle footpegs mentioned and described above. It is comprised of many novel features and advantages, it is made of novel parts, and it performs the functions that result in a new motorcycle footpeg which is not anticipated, rendered obvious, suggested, or even implied by any of the prior art of motorcycle footpegs heretofore known, either alone or in any combination thereof.

The present invention is a pivoting motorcycle footpeg. It is comprised of a hollow shaft member having a first end formed for engagement with a motorcycle frame. The first end is also formed to receive a formed first end of a torsion bar to prevent the bar from rotating. A footpad having a receptacle is formed on the lower side of the footpad for receiving the shaft member for partial oscillating rotational motion of the footpad around the shaft disposed in the receptacle.

A torsion bar is disposed internally of the shaft and formed for extending through the shaft member. The torsion bar has a first end thereof formed for engaging the shaft member in locked relation. The opposite second end of the torsion bar is formed for engaging the footpad in locked rotational relation whereby as the footpad rocks with oscillating partial rotational motion imposed upon it by the motorcycle riders foot, the torsion bar resists the induced torsional stress.

The more important features of the invention have been broadly outlined in the preceeding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a rider adjustable foot support for pivoting orientation of the footpad on a motorcycle footpeg.

It is another object of the present invention to provide a pivoting motorcycle footpeg which is biased to a predetermined foot rest position.

It is a further object of the present invention to provide a pivoting motorcycle footpeg which provides rider stability yet accommodates a range of angulation of the rider's foot.

It is still another object of the present invention to provide a pivoting motorcycle footpeg which is a simple and reliable yet sturdy but of relatively inexpensive construction in comparison with the prior art.

And it is yet a further object of the present invention to provide a pivoting motorcycle footpeg which is biased by an internal torsion bar.

Other objects and advantages of the present invention will become apparent when the apparatus of the present invention is considered in conjunction with the accompanying drawings.

### DESCRIPTION OF THE DRAWINGS

The invention is illustrated in the accompanying drawings but not limited by reference to the particular embodiments shown therein of which:

FIG. 1 is an exploded perspective view of the footpeg of the present invention;

FIG. 2 is a top perspective view of the footpeg thereof, and

FIG. 3 is a top perspective view of the footpeg of the present invention

### DESCRIPTION OF THE PREFERRED EMBODIMENT

Reference is made to the drawings for a description of the preferred embodiment of the present invention wherein like reference numbers represent like elements on corresponding views.

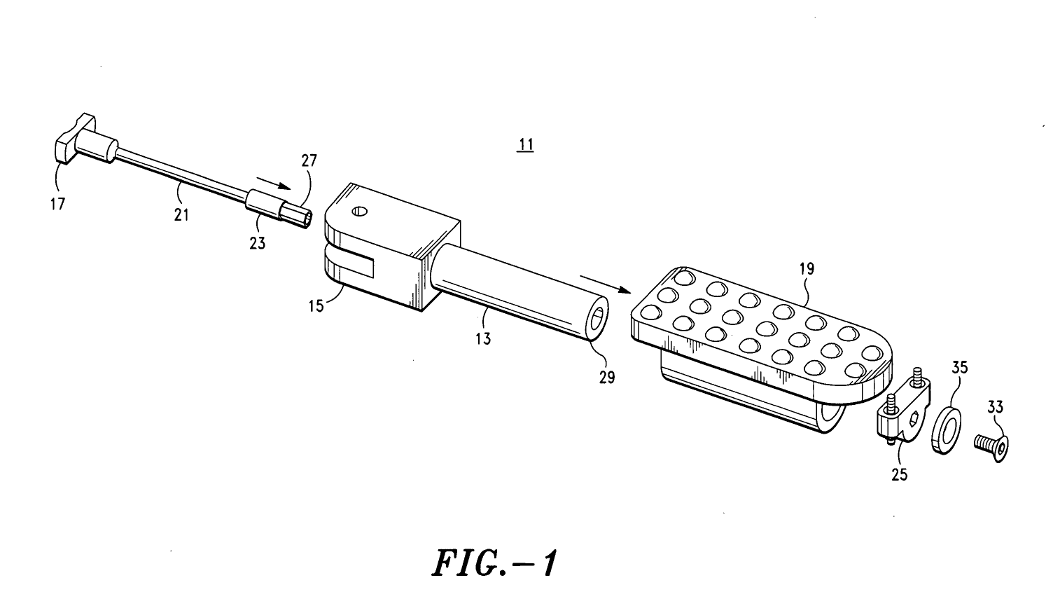

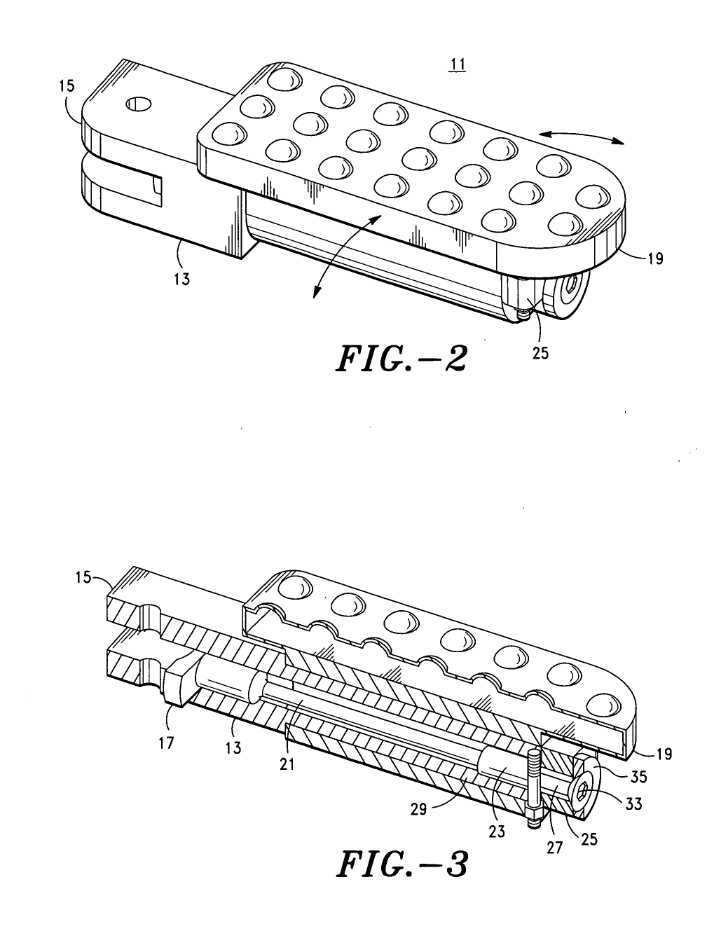

FIGS. 1-3 show a pivoting motorcycle footpeg 11 which is comprised of a minimum of heavy-duty parts. A footpeg is mounted low on a motorcycle frame to provide a platform to support the rider's foot high enough above the ground to prevent contact with the road or the earth surface. This is true in almost all conditions of bike motion including rough terrain and steep angles of lean and high-speed turns. The footpeg is a short cantilever apparatus standard on all motorcycles.

The footpeg of the present invention is comprised of a hollow shaft member 13 having a first end 15 formed for engagement with a motorcycle frame. The first end is a double prong fork 17 forming a slot centered on the first end there of for engaging a standard cantilever engagement fixture projecting from the motorcycle frame. The projection is disposed at the lower end of the motorcycle frame proximate to the rider's feet. The double prong fork of the shaft first end is also formed to receive a formed first end on a torsion bar to interlock the shaft and torsional bar for combined rotation when the torsion bar is secured in the shaft.

The footpad 19 for the footpeg has a tubular receptacle formed on the lower side thereof for receiving the shaft member 13. The fit between the parts permits partial oscillating rotational motion of the footpad around the shaft when it is disposed in the receptacle.

A torsion bar 21 is disposed internally of a shaft 13 and extends through the shaft member. It has the first end thereof 17 formed for engaging the double prong fork of the shaft member to effect the interlock when the torsion bar is inserted into the shaft. This is effected by having the first end of the torsion bar T shaped for engaging the slot in the hollow shaft when the bar is inserted into the shaft member whereby the wings of the T fit between the prongs of the forked first end of the shaft. The torsion bar is positioned in the shaft by this first end when the footpeg is attached to the motorcycle. The second end 23 of the torsion bar also secures it in the shaft.

The opposite second end 23 of the torsion bar is formed for engaging the footpad 19 in interlocked rotational relation whereby as the footpad is rocked with oscillating motion by the motorcycle rider, the torsion bar 21 resists the induced alternating rotational motion. The second end of the torsion bar projects from the opposite end of the shaft member 13 from the first end for engaging the footpad with a disconnectable male and female interconnection.

The interconnection between the second end 23 of the torsion bar 21 and the shaft 13 can be comprised of any interlockable male/female configuration. A removable bracket 25 is secured to the footpad 19 and has a receptacle formed to engage the second formed end of the torsion bar in locking relation whereby rotational motion of the footpad is translated to the torsion bar. The second end 23 of the torsion bar, in the preferred embodiment of the present invention, has a male hexagonal configuration 27 which fits in a female hexagonal configuration receptacle formed in the bracket.

When the torsion bar 21 is inserted into the shaft member 13, the bracket 25 can be fitted to the torsion bar and then secured to the footpad with a disconnectable engagement means, such as bolts through the bracket into the footpad, or any other means which holds the fitting to the footpad. This locks the apparatus together and causes the torsion bar to be stressed from its predetermined neutral position as the motorcycle rider shifts the angulation of his foot on the footpad of the footpeg.

A removable mechanical barrier is secured to the 2nd end 29 of the shaft 13 to hold the formed second end 23 of the torsion bar 21 in the male/female interlock. A tapped hole 31 in the second end of the shaft can engage a screw 33 with a washer 35 which holds the 2nd end of the torsion bar in the shaft.

It will be realized that a great advantage of the present invention is that it can be removed and disassembled by removing just two bolts: the one holding the footpad to the frame through the forked end of the footpad and the screw and washer at the 2nd end of the shaft holding the torsion bar in the shaft; Thus it is easy to clean and relubricate the pivoting motorcycle footpeg.

Thus it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. A motorcycle footpeg comprising
a hollow shaft member having a first end formed for engagement with a motorcycle frame, said first end also formed to receive a formed first end of a torsion bar to interlock said shaft and said torsion bar for combined rotation,
a footpad having a receptacle formed on the lower side thereof for receiving said shaft member for partial oscillating rotational motion of said footpad around said shaft disposed in said receptacle, and
a torsion bar disposed internally of said shaft and formed for extending through said shaft member and having said first end thereof formed for engaging said shaft member in locked relation and the opposite second end of said bar formed for engaging said footpad in locked rotational relation whereby as said footpad rocks with oscillating partial rotational motion said bar resists the induced torsional stress.

2. The motorcycle footpad of claim 1 wherein said hollow shaft number has a double prong forked end forming a slot centered on said first end there of for engaging a protection on said motorcycle frame, and
said torsion bar has a T shaped first end formed for engaging said slot when said bar is inserted into said shaft member.

3. The motorcycle footpad of claim 1 wherein said torsion bar second end projects from the opposite end of said shaft member from said first end for engaging said footpad with a disconnectable male/female rotation locked interconnection.

4. The motorcycle footpad of claim 3 wherein a removable bracket is secured to said lower side of said footpad and has a female receptacle formed to engage said second formed end of said torsion bar in locking relation whereby rotational motion of said footpad is translated to said torsion bar.

5. A motorcycle footpeg comprising
a hollow shaft member having a first end formed with a double prong forked end forming a slot centered on said first end there of for engaging a projection on a motorcycle frame, said slot also formed to receive a formed first end of a torsion bar to interlock said bar and said shaft member for combined rotation,
a footpad having a receptacle formed on the lower side thereof for receiving said shaft member internally thereof for partial oscillating rotational motion of said footpad around said shaft disposed in said receptacle, and said footpad having a bracket secured to said lower side thereof and having a female receptacle formed to engage the second end of said torsion bar in locking relation whereby rotational motion of said footpad is translated to said torsion bar, and
a torsion bar disposed internally of said shaft and formed for extending through said shaft member and having a T shaped first end thereof formed for engaging said slot of said shaft member in locked relation when torsion bar is inserted into said shaft member and the opposite second end of said torsion bar projects from the opposite end of said shaft member from said first end for engaging said footpad with a disconnectable male/female rotation locked interconnection whereby as said footpad rocks with oscillating partial rotational motion said bar resists the induced torsional stress.
